(19) United States
(12) Patent Application Publication
(10) Pub. No.: US 2005/0045783 A1
(43) Pub. Date: Mar. 3, 2005

(54) Adjustable stand

(76) Inventor: Fred R. Brumley, Oak Grove, LA (US)

Correspondence Address: John M. Harrison, 2139 E. Bert Kouns, Shreveport, LA, 71105, US

(21) Appl. No.: 10/929,863

(22) Filed: Aug. 30, 2004

Related U.S. Application Data
(60) Provisional application No. 60/499,474, filed on Sep. 3, 2003.

(51) Int. Cl. F16M 11/02

(52) U.S. Cl. 248/181.1; 248/431; 248/440.1

(57) ABSTRACT

An adjustable stand which is characterized by a workstock support having a flat or concave work surface area and an upward-standing rim or lip, with an engaging flange at one end and a chain lock apparatus at the opposite end for securing a workstock in place on the workstock support. A threaded rod and yoke assembly is provided in the chain lock system for tightening the chain in the chain lock apparatus against the workstock seated on the flange. A tripod support is typically provided, wherein support legs extend from a ball adjustably mounted in a collar fixed to a base mount or to the bottom of the workstock support, to a supporting surface. This assembly facilitates universal rotation of the workstock support and the collar in unison on the ball, to adjust the workstock support and the workstock to be welded into a desired angular configuration with respect to the supporting surface. Thumb screws or T-bolts are threaded through the collar to selectively engage the ball and facilitate adjustment and secure positioning of the support base and the workstock in a desired configuration on the ball.

### CROSS-REFERENCE TO RELATED APPLICATIONS

This application claims the benefit of and incorporates by reference prior filed U.S. Provisional Application Ser. No. 60/499,474, filed Sep. 3, 2003.

### SUMMARY OF THE INVENTION

An adjustable stand is designed to removably immobilize and universally position workstock, typically for welding purposes. The adjustable stand includes a workstock support of suitable size, preferably characterized by a flat or concave, upward-facing base portion, terminating in an upward-standing perimeter lip or rim and fitted with an engaging flange at one end and a chain lock apparatus at the opposite end for removably securing the workstock on the workstock support. The chain in the chain lock apparatus is typically selectively tightened and loosened in conventional fashion by operation of a rod threaded in the workstock support and engaging the chain and a yoke handle and yoke combination are rotatably mounted on the workstock support and threaded on the threaded rod for raising and lowering the threaded rod in the workstock support into and from contact with the chain. In a preferred embodiment a tripod support is provided, wherein the three support legs converge from support level upwardly into secure engagement with a ball captured in a ball collar which is welded or otherwise fixed to a base mount or directly to the underside of the workstock support. Thumb screws or T-bolts are typically threaded through the ball collar at radially spaced-apart intervals around the ball collar for selectively disengaging and engaging the ball and facilitating manipulation and fixed orientation of the support base, the workstock and the ball collar in unison on the fixed ball and positioning the workstock in selected positions, typically for welding.

### BRIEF DESCRIPTION OF THE DRAWINGS

The invention will be better understood by reference to the accompanying drawings, wherein:

FIG. 1 is a top perspective view of a preferred embodiment of the adjustable stand of this invention;

FIG. 2 is a bottom perspective view of the adjustable stand illustrated in FIG. 1;

FIG. 3 is a front view of the adjustable stand illustrated in FIGS. 1 and 2, more particularly illustrating an adjustable orientation of the workstock, support base mount and ball collar in a first selected orientation;

FIG. 4 is a side view of the adjustable stand illustrated in FIG. 3, illustrating further adjustment of the workstock support, base mount and ball collar in a second desired orientation;

FIG. 5 is a sectional view taken along line 5-5 of the adjustable stand illustrated in FIG. 2;

FIG. 6 is an exploded view of base mount, ball collar and ball elements of a preferred embodiment of the adjustable stand; and

FIG. 7 is an exploded view of the adjustable stand illustrated in FIGS. 1-6;

### DESCRIPTION OF THE PREFERRED EMBODIMENTS

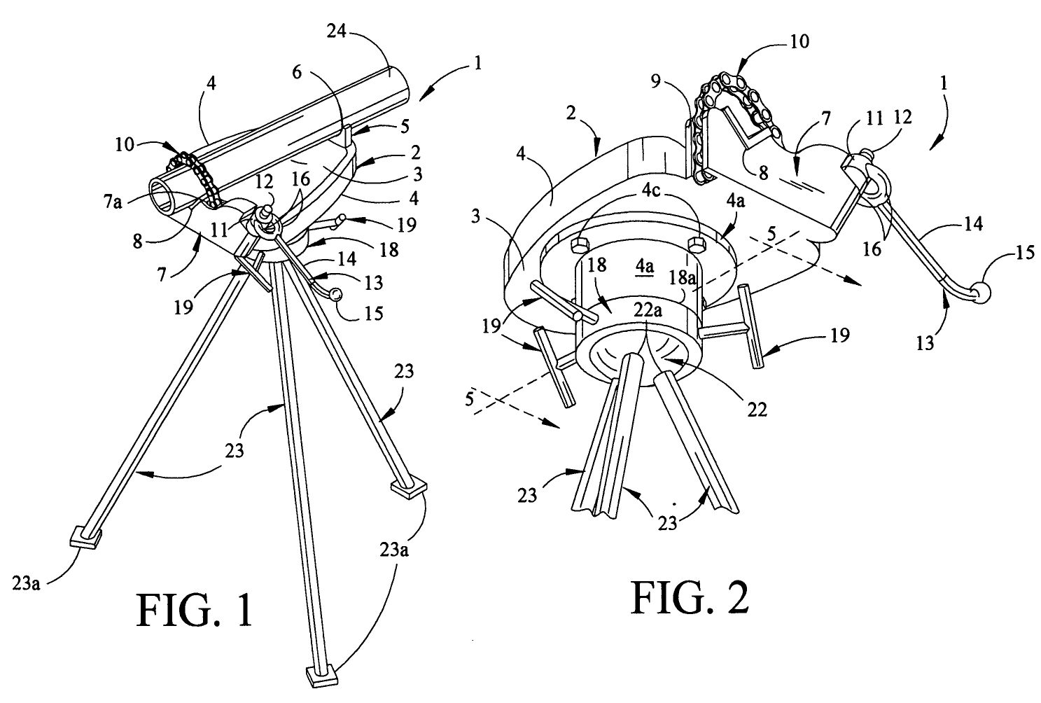

Referring initially to FIGS. 1 and 2 of the drawings, in a preferred embodiment the adjustable stand of this invention is generally illustrated by reference numeral 1. The adjustable stand 1 includes a workstock support 2 of selected size and shape, but preferably oval and flat or dish-shaped, as illustrated in FIG. 1. The workstock support 2 is thus typically characterized by a flat or concave support base 3, which terminates in a base rim or lip 4 extending around the periphery of the support base 3. An engaging flange 5 is typically provided in one end of the long axis of the support base 3 and a support block 7 is provided at the opposite end thereof. A flange notch 6 is typically provided in the engaging flange 5 and a V-shaped chain saddle 8 is typically shaped in the support block 8 for receiving and stabilizing a workstock 24 on the workstock support 2, as illustrated in FIG. 1. The chain saddle 8 is also fitted with a chain saddle slot 9 that receives one end of a chain 10 and is shaped to selectively receive and engage the chain 10 and immobilize the chain 10 on the chain saddle 8. The opposite end of the chain 10 extends through an opening or block slot 7a in the support block 7 and loops downwardly for fixed attachment (not illustrated) to the support base 3 in conventional fashion.

As illustrated in FIGS. 1-4 of the drawings, in a preferred embodiment a threaded collar 11 is journalled for rotation in the support block 7 and threadably receives a threaded rod 12, also threaded in the support base 3, such that rotation of the threaded rod collar 1 1 causes the threaded rod 12 to move up and down in the threaded rod collar 11 and selectively contact the chain 10 in conventional fashion. A yoke 13 is provided with a yoke handle 14 that extends at one end to define a pair of spaced-apart or bifurcated yoke arms 16, which mount diametrically on the threaded rod collar 11, to facilitate rotation of the yoke handle 14 by grasping the ball 15 located on the opposite end of the yoke handle 14 and turning the threaded rod collar 11 to raise and lower the threaded rod 12 in the thread rod collar 11, further in conventional fashion. Accordingly, lowering of the threaded rod 12 in this manner using the threaded rod collar 11, selectively places tension on that portion of the chain 10 that loops downwardly through the block slot 7a in the support block 7 and connects to the support base 3, for conventionally immobilizing the workstock 24, bound by the chain 10 and seated in the oppositely disposed flange notch 6 of the engaging flange 5, on the workstock support 2.

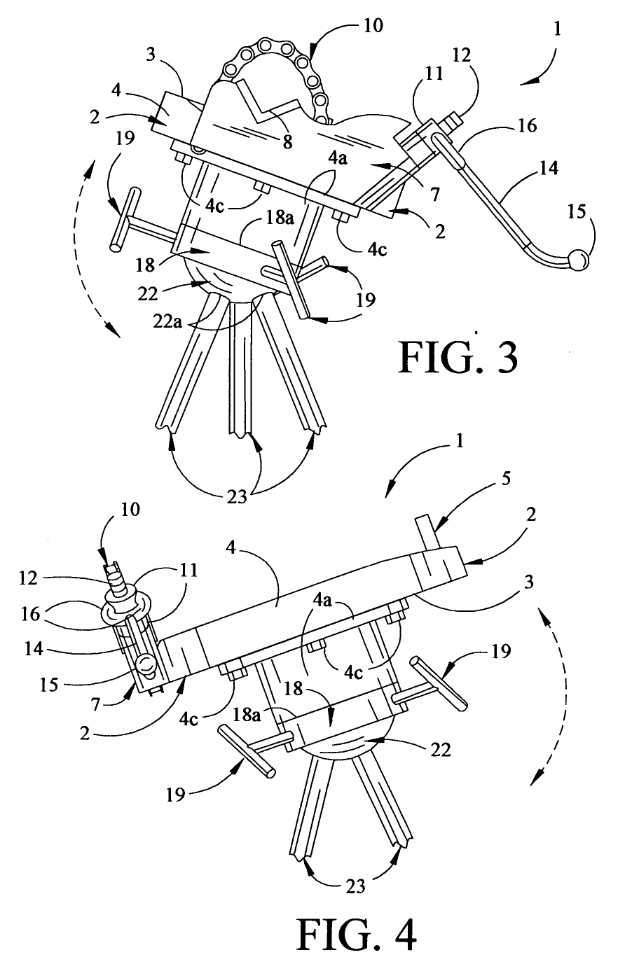

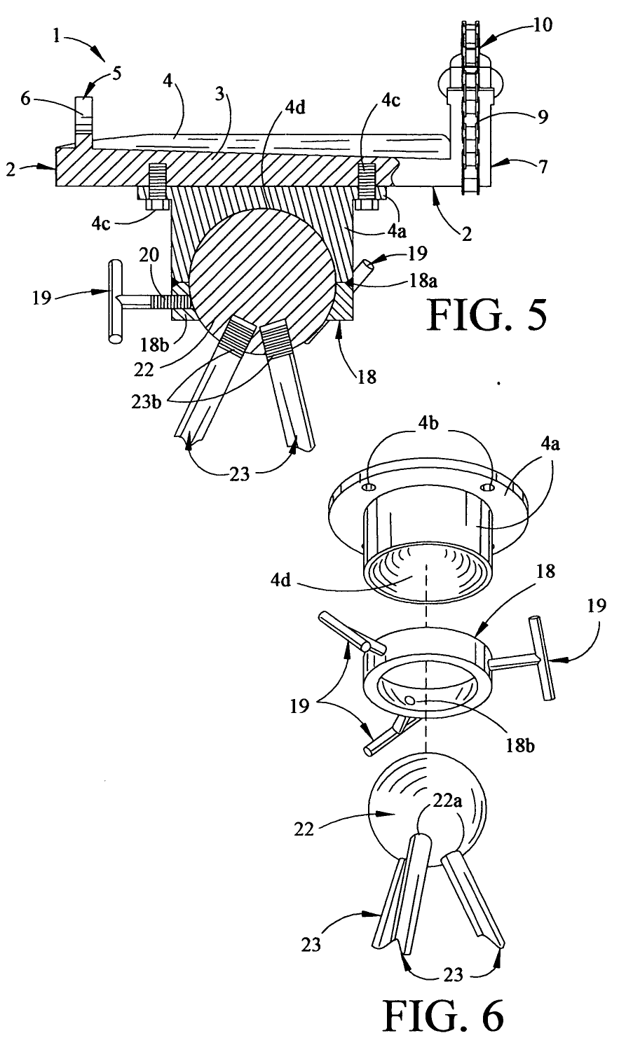

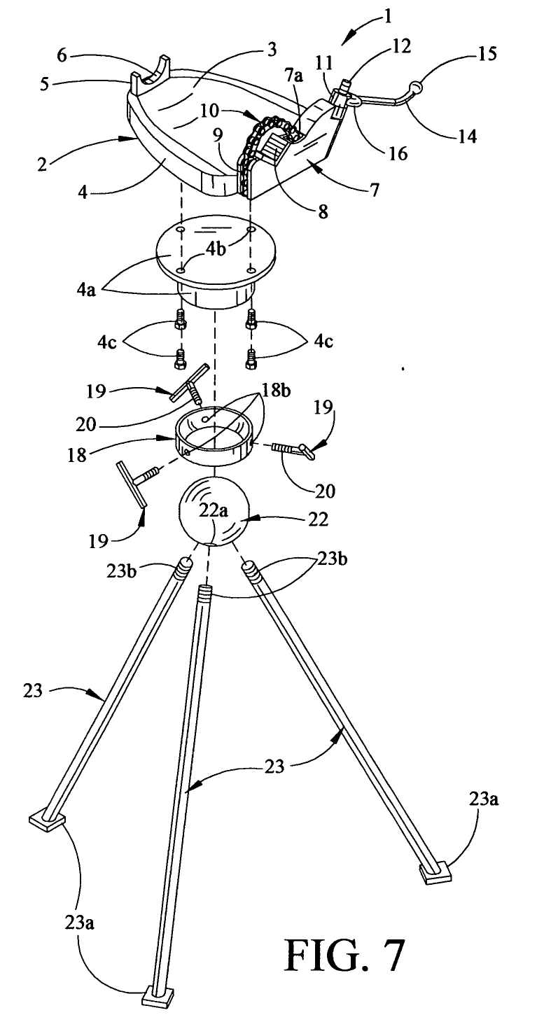

Referring now to FIGS. 1-6 of the drawings, three, downwardly-extending ball legs 23 are each fitted with a leg plate 23a for resting on a supporting surface and the opposite ends of the ball legs 23 converge for fixed attachment to a ball 22 in any appropriate manner, but typically by threading the leg threads 23b into corresponding ball sockets 22a in the ball 22, as illustrated in FIGS. 5 and 6. Alternatively, the ball legs 23 can be welded to the ball 22 or they may be threadably seated in threaded nipples (not illustrated), extending from the ball 22 or the ball legs 23 may be fixed or removably mounted to the ball 22 in any other convenient manner. The ball legs 23 are therefore immobile with respect to the ball 22. Furthermore, as illustrated in FIGS. 2, 5 and 6, in a preferred embodiment the ball 22 is captured in the base recess 4d of a base mount 4a, having base mount bolt openings 4b (FIG. 6), along with a ball collar 18, both of which receive the ball 22 and are adjustable on the ball 22. The ball collar 18 is then welded at a collar weld 18a (FIG. 2) or is otherwise fixed to the base mount 4a, which is typically bolted to the underside of the support base 3, by means of base mount bolts 4c that extend through the mount bolt openings 4b. The ball collar 18 is fitted with spaced-apart, threaded collar T-bolts 19 that extend radially through the ball collar 18 for selective engagement with the ball 22, as further illustrated in FIGS. 2, 5 and 6 of the drawings. Accordingly, the T-bolt threads 20 of the collar T-bolts 19 engage corresponding threaded openings 18b in the ball collar 18 (FIGS. 5 and 6) to facilitate selective tightening and loosening of the extending ends of the collar T-bolts 19 against the ball 22. Since the ball 22 is fixed to and supported by the ball legs 23 and both the base mount 4a and the ball collar 18 ride on the ball 22 in an adjustable manner, and since the ball collar 18 is welded or otherwise fixed to the base mount 4a, and the base mount 4a is secured to the underside of the support base 3, the support base 3, workstock 24, base mount 4a and the ball collar 18 are adjustable in concert with respect to the ball 22 by adjustment of the collar T-bolts 19. This facility allows universal adjustment of the workstock 24, secured by the chain 10 and extending to the engaging flange 5, in any convenient configuration, typically for welding purposes, as illustrated in FIGS. 3 and 4 of the drawings.

Referring now to FIGS. 1, 3, 4 and 6 of the drawings, in operation the adjustable stand 1 is utilized to immobilize a workstock 24 (FIG. 1) in any convenient position and configuration with respect to a supporting surface, as follows. The workstock 24 is first positioned on the workstock support 2 by removing the free end of the chain 10 from the corresponding chain saddle slot 9 in the chain saddle 8 and then resting the workstock 24 in the chain saddle 8 and in the flange notch 6 of the engaging flange 5, spaced from the support block 7. The chain 10 is then looped over the workstock 24 and the chain 10 is caused to engage the chain saddle slot 9 in the chain saddle 8, as further illustrated in FIG. 1 of the drawings. The yoke handle 14 of the yoke 13 is then rotated by grasping the ball 15, to drive the threaded rod 12 downwardly against the looped fixed portion of the chain 10 (not illustrated) and tighten the chain 10 against the workstock 24 in conventional fashion, which renders the workstock 24 immobile for purposes such as welding. The workstock support 2, along with the workstock 24, is then adjusted to a selected access position by loosening the respective collar T-bolts 19, threaded in the ball collar openings 18b of the ball collar 18, to facilitate universal rotation of the workstock support 2, the workstock 24, the base mount 4a and the ball collar 18 with respect to the ball 22 and position the workstock 24 into a desired configuration with respect to the ball 22 and the supporting surface 25, for convenient working or welding of the workstock 24 (FIGS. 3 and 4).

It will be appreciated by those skilled in the art that the adjustable stand of this invention can be shaped in any desired configuration, the flat or generally concave shaped work surface on the support base 3 being illustrative only. Furthermore, the size of the workstock support 2 can be varied, as well as the size and type of the chain 10, and the distance between the support block 7 and the oppositely-disposed engaging flange 5 may vary, depending upon the nature, type and size of the workstock 24 to be secured to the workstock support 2. Moreover, alternative clamping or securing devices can be used to secure the workstock 24 on the workstock support 2 and the height of the workstock support 2 above a supporting surface 25 can be made adjustable by providing telescoping ball legs 23 and spring-loaded buttons in the ball legs 23, as desired.

While the preferred embodiments of the invention have been described above, it will be recognized and understood that various modifications may be made in the invention and the appended claims are intended to cover all such modifications which may fall within the spirit and scope of the invention.

1. An adjustable stand for securing a workstock, comprising a ball; at least three support legs extending from said ball for supporting the ball above a surface; a collar at least partially encircling said ball for adjustably containing said ball; at least one engaging means carried by said collar for selectively disengaging and engaging said ball; and a workstock support carried by said collar, wherein said workstock support and the workstock are adjustable with said collar on said ball responsive to said disengaging and engaging of said engaging means with said ball while said ball and said legs remain static.

2. The adjustable stand of claim 1 comprising a chain provided on said workstock support for removably engaging the workstock and securing the workstock on said workstock support.

3. The adjustable stand of claim 2 comprising an engaging flange provided on said workstock support in spaced-apart relationship with respect to said chain for receiving the workstock and stabilizing the workstock on said workstock support.

4. The adjustable stand of claim 2 comprising a chain-tightening apparatus provided on said workstock support for selectively engaging and tightening said chain against the workstock.

5. The adjustable stand of claim 4 comprising an engaging flange provided on said workstock support in spaced-apart relationship with respect to said chain for receiving the workstock and stabilizing the workstock on said workstock support.

6. The adjustable stand of claim 4 wherein said chain-tightening apparatus comprises a threaded rod threadably carried by said workstock support and a rod collar rotatably carried by said workstock support, said rod collar threadably engaging said threaded rod and selectively extending said threaded rod against said chain for securing the workstock on said workstock support responsive to rotation of said rod collar.

7. The adjustable stand of claim 6 comprising a yoke attached to said rod collar and a handle extending from said yoke for rotating said rod collar responsive to rotation of said handle.

8. The adjustable stand of claim 7 comprising an engaging flange provided on said workstock support in spaced-apart relationship with respect to said chain for receiving the workstock and stabilizing the workstock on said workstock support.

9. An adjustable stand for supporting a workstock, comprising a ball; at least three legs having one end fixed to said ball and the opposite ends of said legs extending to a supporting surface; a base mount and a collar adjustably capturing said ball, said collar attached to said base mount; at least one ball-engaging member adjustably carried by said collar for selectively disengaging and engaging said ball; and a workstock support fixedly carried by said base mount, whereby said collar, said base mount, said workstock support and the workstock are adjustable on said ball responsive to said disengaging and engaging of said engaging means with said ball.

10. The adjustable stand of claim 9 comprising a workstock clamping apparatus provided on said workstock support for removably engaging the workstock and securing the workstock on said workstock support.

11. The adjustable stand of claim 10 comprising an engaging flange provided on said workstock support in spaced-apart relationship with respect to said workstock clamping apparatus for receiving the workstock and stabilizing the workstock on said workstock support.

12. The adjustable stand of claim 10 wherein said workstock clamping apparatus comprises a chain-tightening apparatus and a chain for selectively engaging and tightening said chain against the workstock.

13. The adjustable stand of claim 12 wherein said chain-tightening apparatus comprises a threaded rod threadably carried by said workstock support, said threaded rod engaging said chain and a rod collar rotatably carried by said workstock support, said rod collar threadably engaging said threaded rod and selectively extending said threaded rod against said chain for securing the workstock on said workstock support responsive to rotation of said rod collar.

14. The adjustable stand of claim 13 comprising a yoke attached to said rod collar and a handle extending from said yoke for rotating said rod collar responsive to rotation of said handle.

15. The adjustable stand of claim 14 comprising an engaging flange provided on said workstock support in spaced-apart relationship with respect to said chain for receiving the workstock and stabilizing the workstock on said workstock support.

16. An adjustable stand for securing, supporting and welding a workstock, comprising a ball; at least three legs having one end secured to said ball and the opposite ends of said legs extending to a supporting surface; a base mount having a ball recess for receiving said ball; a collar adjustably capturing said ball, said collar secured to said base mount; at least one ball-engaging member threadably carried by said collar for selectively disengaging and engaging said ball; and a workstock support fixedly carried by said ball mount, whereby said collar, said ball mount, said workstock support and the workstock are adjustable on said ball responsive to adjustment of said engaging means and selectively disengaging and engaging said ball.

17. The adjustable stand of claim 16 comprising a workstock clamping apparatus provided on said workstock support for removably engaging the workstock and securing the workstock on said workstock support.

18. The adjustable stand of claim 17 comprising an engaging flange provided on said workstock support in spaced-apart relationship with respect to said workstock clamping apparatus for receiving the workstock and stabilizing the workstock on said workstock support.

19. The adjustable stand of claim 18 wherein said workstock clamping apparatus comprises a chain-tightening apparatus and a chain provided on said workstock support for selectively engaging and tightening said chain against the workstock.

20. The adjustable stand of claim 19 wherein said chain-tightening apparatus comprises a threaded rod threadably carried by said workstock support, said threaded rod engaging said chain, a collar rotatably carried by said workstock support, said collar threadably engaging said threaded rod, a yoke attached to said collar and a handle extending from said yoke for rotating said collar and selectively extending said threaded rod against said chain for securing the workstock on said workstock support.
